(19) United States
(12) Patent Application Publication
(10) Pub. No.: US 2026/0288520 A1
(43) Pub. Date: Sep. 24, 2026

(54) MANAGING MEMORY RESOURCE ALLOCATION FOR SOFTWARE APPLICATIONS

(71) Applicant: Hewlett Packard Enterprise Development LP, Spring, TX (US)

(72) Inventors: Sai Rahul Chalamalasetti, Pleasanton, CA (US); Eric Pope, Tomball, TX (US); Melvin K. Benedict, Magnolia, TX (US); Joseph Hoch, Cypress, TX (US)

(21) Appl. No.: 19/083,247

(22) Filed: Mar. 18, 2025

(51) Int. Cl. G06F 9/50; G06F 13/42

(52) U.S. Cl. CPC G06F 9/5016; G06F 9/5055; G06F 13/4282

(57) ABSTRACT

In certain implementations, a computer-implemented method includes accessing, by a compiler, system configuration information describing memory resources of an execution computing environment, the memory resources being at least partially heterogeneous. The method includes accessing, by the compiler, source code for a software application to be executed in the execution computing environment. The source code includes memory preference indicators for data items associated with the software application. The memory preference indicators indicate preferred memory characteristics for storing the data items in association with execution of the software application. The method includes analyzing, by the compiler, the source code and the system configuration information to determine a mapping of the memory resources to the data items according to the memory preference indicators and system configuration information. The method includes generating, by the complier and according to the mapping, memory allocation metadata comprising memory placement guidance for the data items.

### BACKGROUND

Software applications provide instructions that cause a computer system to perform certain desired operations. Software applications may be developed for deployment to different types of execution environments, including a standalone computing environment or a distributed computing environment. A computer system that executes a software application may use one or more types of memory to store and access data items in association with software application execution. The data items may include program code, data structures, variables, and/or any other suitable types of data items. In some scenarios, an operating system (OS) of the computer system manages what portions of the memory resources of a computer system are allocated to the data items.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 illustrates an example system for managing memory resource allocation for software applications, according to certain implementations;

FIG. 2 illustrates an example compilation environment, according to certain implementations;

FIG. 3 illustrates an example execution computing environment, according to certain implementations;

FIG. 4 illustrates an example method for managing memory resource allocation for software applications, according to certain implementations;

FIG. 5 illustrates an example method for managing memory resource allocation for software applications, according to certain implementations; and

FIG. 6 illustrates an example scenario of managing memory resource allocation for multiple software applications, according to certain implementations.

### DESCRIPTION

Software applications execute various operations with respect to memory resources. For example, some software applications may perform “read” operations in which the software application requests certain data items from one or more memory resources. As another example, some software applications may perform “write” operations in which the software application requests that one or more memory resources store data items. Of course, a software application may execute any suitable types of operation, alone or in combination, with respect to memory resources.

Computer systems have evolved to include different types of memory resources, such as local memory, internal memory, direct attached storage (DAS), fabric-attached memory (FAM), and/or other types of memory resources. These heterogeneous memory resources may be arranged logically in a hierarchy, with different types of memory having different characteristics in terms of speed (e.g., latency), bandwidth, capacity, and cost (e.g., load-to-use latency, operational power, acquisition cost, and/or other suitable types of costs). Local memory may refer to the registers and caches (e.g., Layer-1 (L1), L2, or L3 caches) that are internal to the processor. Local memory may refer to memory devices that are directly attached to the processor, such as Dynamic Random-Access Memory (DRAM) or Synchronized DRAM (SDRAM), that generally are mounted to one or more slots on a motherboard that includes the processor(s). An example form factor of local memory may be one or more dual in-line memory modules (DIMMs) that can be mounted to slots on the motherboard. Both local memory and internal memory may be considered primary storage, and may provide fast access speeds but may have limited capacity and may be more expensive per bit than other types of memory. Secondary storage, such as solid state drives (SSDs) or hard disk drives (HDDs), may have a larger capacity at lower cost but may have slower (and potentially significantly slower) access speeds. Some secondary storage may be referred to as direct-attached storage (DAS), and may include any memory resources directly connected to the computer system, generally without traversing a communication network, such as a switch fabric. Secondary storage often includes non-volatile memory. FAM may refer to memory resources that are coupled to the processor(s) via a communication network, such as a switch fabric. In some implementations, FAM may be locally attached, attached via a switch fabric, or a combination of both.

Processors may interact with memory resources via one or more memory interfaces. One example memory interface is the double data rate (DDR) interface, often used to communicate with DRAM or SDRAM. Another example memory interface, often used to communicate with certain types of secondary storage devices (e.g., SSDs or HDDs), is Serial Advanced Technology Attachment (SATA). Some newer memory interfaces include Compute Express Link (CXL), Open Memory Interface (OMI), Open Coherent Accelerator Processor Interface (OpenCAPI), and Gen-Z. Taking CXL as an example, CXL is built on the Peripheral Component Interconnect Express (PCIe) serial expansion bus standard, and may be used with both direct attached memory resources and/or to couple one or more memory resources to the processor(s) via a switch fabric.

The different memory resources and memory interfaces may have certain advantages and disadvantages relative to one another. Implementing a system that includes a mix of these or other memory resources and memory interfaces—a so-called heterogeneous system—may provide a balanced and/or cost-effective system that can serve different software application and other objectives. For example, the heterogeneous memory resources may exhibit different memory latency and/or memory bandwidth characteristics. Memory latency generally refers to the time it takes for a memory request to be processed and data to be retrieved. For example, with a “read” request, memory latency may be the time delay between a processor initiating a memory access and the processor receiving the data in response. Memory bandwidth generally refers to the rate at which data can be transferred to and from memory. For example, with both “read” and “write” requests, memory bandwidth refers to the amount of data that can be moved (read and/or written) per unit time.

Whether due to the memory resources themselves or the interfaces to the memory resources, some memory resources may be more optimal for certain types of operations in a software application, while other types of memory resources may be more optimal for other types of operations in a software application. An operating system may manage the allocation and use of the various types of memory resources available in a computer system. When an application requests memory, the operating system may allocate available memory without detailed knowledge of the application’s specific performance objectives for different data items (e.g., data structures). As working set sizes of applications continue to grow, challenges associated with providing sufficient memory capacity while maintaining desired performance levels increase. While new memory technologies and interfaces like CXL provide expanded memory capacity through fabric-attached memory devices, these memory devices may be heterogeneous, including potentially having different performance characteristics. Effectively and/or optimally managing the placement and management of application data across these heterogeneous memory resources remains a challenge.

Certain implementations provide techniques for optimizing memory allocation across heterogeneous memory resources through compiler-directed memory management or hints. A compiler receives source code for a software application, along with system configuration information describing available memory resources for a computer system in which the software application will be executed. The source code may include memory preference indicators, which may be implemented as compiler directives, to indicate to the compiler preferences for where data items (e.g., data structures) of the software application could be stored. In many programming languages, compiler directives are identified within source code by a leading “#” symbol at the beginning of the line, though of course this disclosure is not limited to that format. Additionally or alternatively, in certain implementations, the compiler may receive or otherwise determine data dependency information, from which the compiler may determine relationships between operations (e.g., read operations and/or write operations) to particular regions of memory resources, potentially with temporal and/or spatial locality reference. Using the memory preference indicators and system configuration information, the compiler generates metadata that provides guidance about optimal memory placement for different data items, potentially based on data dependencies, access patterns, and performance objectives that the compiler can decipher from the source code. This metadata may be a part of, or included with, the compiled code for the software application, which may then be provided to the computer system in which the software application will be executed.

A memory management and scheduling component of the execution environment may use the metadata to intelligently allocate and manage memory resources, considering the different latency and bandwidth characteristics of the heterogeneous memory resources, such as local versus fabric-attached memory. With insights across multiple applications, the scheduling component might schedule different software applications that compete for the same memory resources in a manner that allows for higher read/write ratios. A read/write ratio may reflect the proportion of read operations to write operations that occur in a computer system, such as during software application execution. For example, allocating memory resources according to memory allocation metadata determined according to this disclosure may increase read/write ratios for both individual software applications and multiple software applications that execute in parallel. The memory management and scheduling component can be one or multiple components and, in certain implementations, may be part of the operating system of the computer system in which the software application will be executed. Furthermore, the memory management and scheduling component may be associated with an individual computer, a compute node of a compute cluster, a head node managing a compute cluster, or other types of systems.

Certain implementations may provide none, some, or all of the following technical advantages. Certain implementations may facilitate managing heterogeneous memory resources in computer systems. In certain implementations, a compiler-directed approach may provide more efficient use of memory resources by allowing software applications to take advantage of both local memory’s lower latency and fabric-attached memory’s expanded capacity without defaulting to the lowest common denominator performance level. Certain implementations may reduce performance variability by providing more predictable memory access patterns. Without such guidance, the same program might experience different performance characteristics from run to run, even within the same execution environment, depending on how memory resources happen to be allocated. Through compiler-generated metadata and intelligent memory management, certain implementations may provide more consistent performance by placing data items in appropriate memory resources.

In certain implementations, the system may optimize aggregate system performance when multiple software applications are running concurrently. By considering the read/write patterns of different applications, the scheduler may co-locate programs on memory resources in ways that take advantage of the different characteristics of local versus fabric-attached memory. For example, software applications with complementary access patterns may be scheduled together to better utilize the bidirectional bandwidth capabilities of fabric-attached memory. The compiler directives and metadata approach may allow memory allocation to adapt to the specific objectives of each application. Rather than using static weights for different memory resources, certain implementations may optimize memory placement based on detailed analysis of each program’s data structures and access patterns. Additionally, certain implementations may be flexible enough to accommodate future memory technologies and topologies. By abstracting the guidance through metadata rather than hardcoding assumptions about specific memory types, implementations may extend to support new memory interfaces and configurations as they become available.

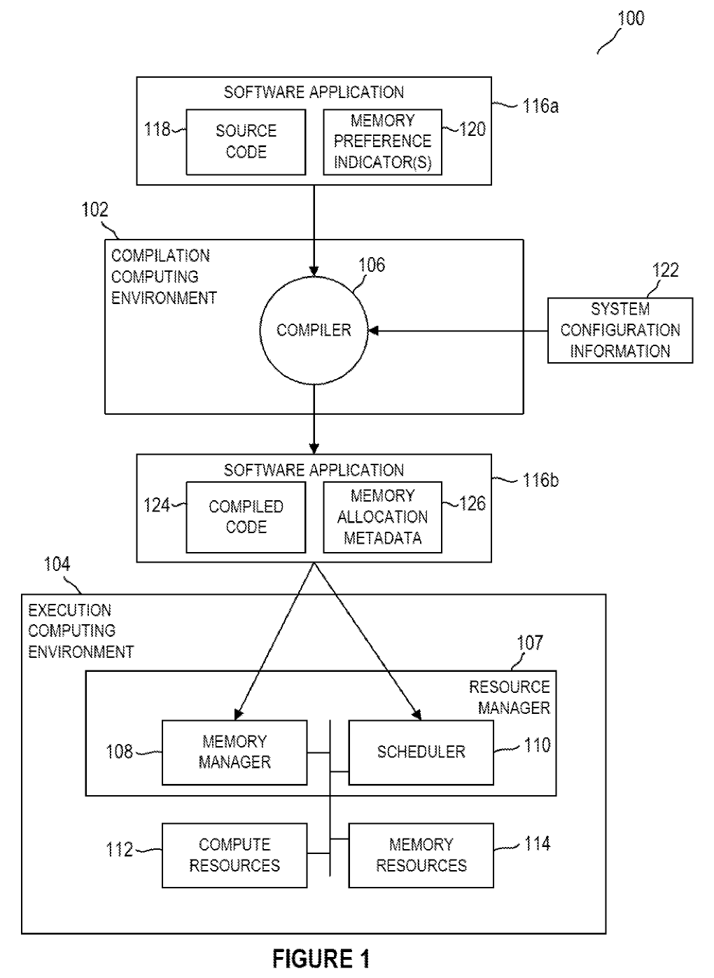

Turning to the figures, FIG. 1 illustrates an example system 100 for managing memory resource allocation for software applications, according to certain implementations. In the illustrated example, system 100 includes a compilation computing environment 102 and an execution computing environment 104. Additionally, in the illustrated example, compilation computing environment 102 includes a compiler 106, and execution computing environment 104 includes a resource manager 107 (that includes memory manager 108 and scheduler 110), compute resources 112, and memory resources 114. Although this arrangement of system 100 is illustrated and primarily described, this disclosure contemplates system 100 having any suitable configuration.

Compilation computing environment 102 (e.g., compiler 106) may be configured to access an uncompiled software application (e.g., uncompiled software application 116a, described below) and compile the uncompiled software application to generate a compiled software application (e.g., compiled software application 116b, described below). Compilation computing environment 102 may receive an uncompiled version of software application 116 (referred to as uncompiled software application 116a) and generate a compiled version of software application 116 (referred to as compiled software application 116b). This disclosure may refer to uncompiled version of software application 116a and compiled version of software application 116b generally as software application 116. Compiler 106 of compilation computing environment 102 may be a software tool configured to translate source code written in a high-level programming language into and machine-executable, or binary, code (e.g., object code).

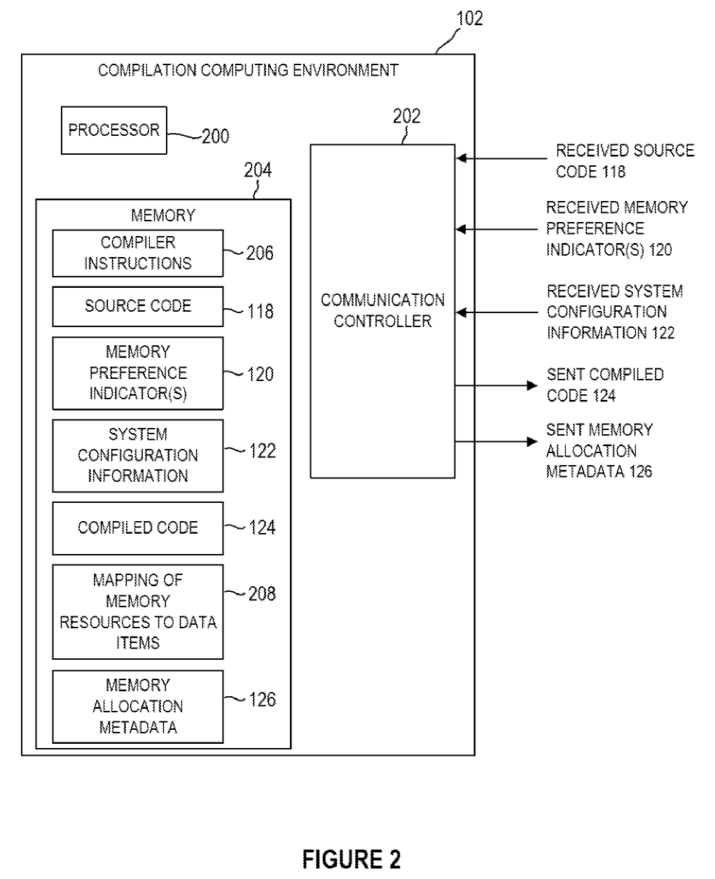

Continuing with FIG. 1, software application 116 may be any suitable type of application to perform any suitable operation or combination of operations. Uncompiled software application 116a may be written in any suitable type of code, and compiler 106 may be configured to compile 106 that type of code to generate compiled software application 116b. Although a single software application is illustrated, compilation computing environment 102 (e.g., compiler 106) may be configured to compile and otherwise process (as described below) any suitable number of software applications 116. Compilation computing environment 102 (e.g., compiler 106) may output the generated compiled software application 116b, such as directly to execution computing environment 104 or to another entity that may provide compiled software application 116b to execution computer environment 104 for execution of software application 116. Compilation computing environment 102, including compiler 106, may be implemented using any suitable combination of hardware, firmware, and software. Additional details of an example compilation computing environment 102 are shown in and described below with reference to FIG. 2.

Execution computing environment 104 may obtain a compiled software application 116b and be configured to execute that compiled software application 116b using compute resources 112 and memory resources 114. Compute resources 112 and memory resources 114 may work together to execute software application 116 and process associated data items.

Compute resources 112 may include any suitable type of processing capabilities of execution computing environment. Compute resources 112 may handle the actual execution of instructions, performing calculations, making decisions, and controlling the flow of programs. Compute resources 112 may include one or more processors at one or more location. The one or more processors may include any suitable combination of central processing units (CPUs), accelerators, application specific integrated circuits (ASICs), field programmable gate arrays (FPGAs), graphics processing units (GPUs), vector processing units, and/or any other suitable types of processing devices. Some of the listed processors may overlap in type. Compute resources 112 may be heterogeneous, and the role of a particular compute resource of compute resources 112 may change from execution to execution of a software application 116 or even during the execution of a software application 116.

Memory resources 114 may provide the storage space for software applications and associated data items. Memory resources 114 may be any suitable type or combination of types of storage, including, for example, any suitable combination of volatile memory, non-volatile memory, and/or virtualizations thereof. For example, memory resources 114 may include any suitable combination of magnetic media, optical media, random access memory (RAM), read-only memory (ROM), removable media, and/or any other suitable memory component. Memory resources 114 may include data structures used to organize and store all or a portion of the stored data.

Memory resources 114 may have one or more characteristics. For example, the one or more characteristics of a particular memory resource 114 may include type, capacity, location (e.g., proximity to compute resources 112), interface (interface technology, such as the DDR interface, the SATA interface, the PCI or PCIe interface, CXL, OMI, OpenCAPI, Gen-Z, or another suitable interface technology), bandwidth, latency, and/or any other suitable characteristics. Regarding type, the type of memory resource 114 could refer to various distinctions in type. One set of types could be volatile vs. non-volatile memory. Another set of types could be local vs. remote. Another set of types could be on-chip vs. direct-attached vs. network-attached. Another set of types could be processor registers, cache memory (e.g., which may be implemented as RAM), RAM and its variants (e.g., DRAM, SRAM, SDRAM, DDR), ROM and its variants (e.g., programmable read-only memory (PROM), erasable programmable read-only memory (EPROM)), flash memory, magnetic disk, optical disk, magnetic tape, etc. Any or all of these or other types could be captured as characteristics of memory resources 114. Some characteristics may depend on other characteristics. For example, while two memory resources 114 might otherwise have identical characteristics and might be at least capable of similar performance, due to one memory resource 114 being located closer to a particular compute resource 112 than another memory resource 114 (and possibly using a different interface technology), the latency and bandwidth values for the two memory resources 114 might differ.

Memory resources 114 may be heterogeneous. In certain implementations, memory resources 114 might be organized into one or more hierarchies each including one or more levels. For example, a first level may be processor memory, which may include processor registers and/or processor cache (e.g., Level 1 cache, Level 2 cache, Level 3 cache, Level 4 cache, etc.), with processor registers typically being faster but scarcer than processor cache. Continuing with this example, a second level of memory may include physical or direct-attached memory, which often includes RAM (e.g., DRAM, SRAM, SDRAM, DDR, etc.). Continuing with this example, a third level of memory may be fabric-attached memory, which may include one or more levels of shared memory, sometimes implemented as RAM. In certain implementations, the fabric-attached memory may be implemented using CXL and may include zero (direct-attached) or more switch layers. In some implementations, this third level may include multiple sublevels. A first sublevel may include direct-attached CXL memory (e.g., directly attached to a compute resource 112). A second sublevel may include pooled CXL memory. A third sublevel may include CXL switch/fabric-attached memory. Continuing with this example, a fourth level may include SSDs (e.g., non-volatile flash-based memory), possibly locally attached. Continuing with this example, a fifth level may include mechanical hard drives, possibly locally attached. In this example hierarchy, latency generally may decrease when moving from the first level to the fifth level, and bandwidth generally may increase when moving from the first level to the fifth level. The hierarchy described above is just one example memory hierarchy. Different execution computing environments 104 may implement memory hierarchies differently.

The characteristics of a particular memory resource 114 may affect latency and/or bandwidth of read and/or write operations, which ultimately may affect how quickly software applications can access and manipulate data. The organization and management of memory resources significantly impact system performance, as the speed of data access often becomes a bottleneck in program execution.

In some implementations, execution computing environment 104 may include at least some memory resources 114 that are considered parallel in terms of characteristics. For example, such parallel memory resources 114 may have generally the same or identical characteristics. Including such parallel memory resources 114 in execution computing environment 04 may reduce memory access interference within a software 116.

Resource manager 107 may be responsible for managing allocation of various resources of execution computing environment 104 to jobs, which may include execution of software applications (e.g., software application 116) and/or processes of software applications (e.g., software application 116). Resource manager 107 may be part of an operating system of execution computing environment 104. Resource manager 107 may include memory manager 108 and scheduler 110, which may cooperate to promote efficient use of system resources and proper execution of software applications 116.

Memory manager 108 may control allocation and deallocation of memory resources 114 to processes (e.g., instances of execution of software application 116 and/or sub-portions of software application 116). For example, memory manager 108 may allocate memory resources 114 to executing instances of software applications 116, including from the heterogeneous types of memory resources 114. Memory manager 108 may use one or more types of memory resources to store and access data items in association with execution of software application 116. The data items may include program code, data structures, variables, and/or any other suitable types of data items. For example, memory manager 108 may manage what portions of memory resources 114 are allocated to the data items.

Scheduler 110 may control allocation of compute resource 112 time to executing software applications 116, including the order in which software applications 116 may use compute resources 112. Scheduler 110 may allocate computer resources 112 to executing software applications 116 according to availability of suitable compute resources 112 for particular software applications 116, relative priorities among software applications 116 and/or sub-portions of software applications 116, and/or according to any other suitable factors. Example scheduling algorithms that may be employed by scheduler 110 may include a round-robin algorithm, a priority-based algorithm, and/or any other suitable type of algorithm.

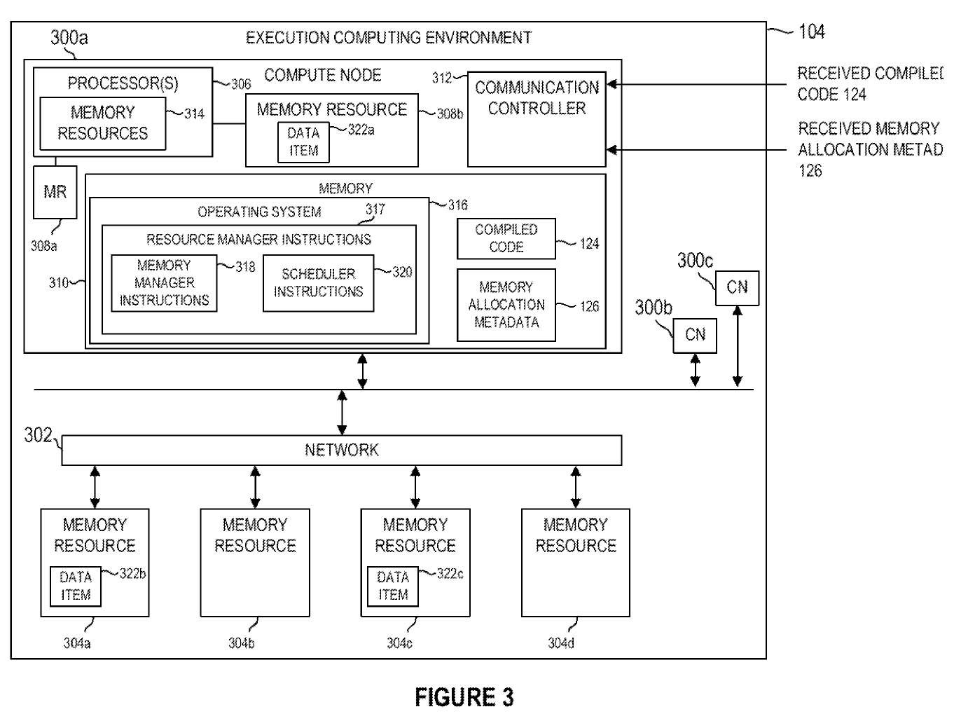

In certain implementations, one or more of memory manager 108 and scheduler 110 may be part of an operating system. For example, memory manager 108 and/or scheduler 110 may be part of an operating system kernel. Furthermore, although memory manager 108 and scheduler 110 are illustrated and primarily described as being separate, memory manager 108 and scheduler 110 may be combined, if appropriate. Execution computing environment 104, including resource manager 107 (e.g., memory manager 108 and scheduler 110), compute resources 112, and memory resources 114, may be implemented using any suitable combination of hardware, firmware, and software. Additional details of an example execution computing environment 104 are shown in and described below with reference to FIG. 3.

In some implementations, execution computing environment may be implemented as a high-performance computing (HPC) computing environment or other type of computer cluster environment. In such an example, memory manager 108 and scheduler 110 may manage and coordinate compute and memory resources 114 that are distributed across multiple compute nodes and/or may be shared by multiple compute nodes, potentially maximizing the locality of references between compute resources 112 and memory resources 114. Memory manager 108 may manage distributed memory resources 114 across compute nodes, handle parallel memory access patterns of memory resources 114, implement features like Non-Uniform Memory Access (NUMA) awareness, facilitate cache coherency across multiple compute resources 112, facilitate high-speed interconnect (e.g., INFINIBAND) management, facilitate message passing interface (MPI) memory optimization, and/or perform other operations. In such an example, scheduler 110 may handle job scheduling (e.g., process and/or software application execution) across multiple compute nodes/clusters, and may use specialized schedulers like SIMPLE LINUX UTILITY FOR RESOURCE MANAGEMENT (SLURM), PORTABLE BATCH SYSTEM (PBS), LOAD SHARING FACILITY (LSF), and/or others. In such an environment, scheduler 110 may consider factors like resource (compute resource 112 and/or memory resource 114) availability across compute nodes, job dependencies and priorities, power consumption optimization, network topology, queue management for multiple users/tenants/projects, and/or other factors.

Continuing with the HPC/computing cluster example, the operating system may be deployed in a layered approach within execution computing environment 104. For example, each compute node may run an instance of a base operating system (e.g., LINUX or another suitable operating system), and this operating system may have a memory manager 108 and scheduler 110. The base operating system may handle local compute node operations. As another example, a cluster management system layer may run on top of the base operating systems of the compute nodes. This cluster management system layer might or might not be considered part of the operating system, but may work with the operating system. The cluster management system layer may include a resource manager/job scheduler (e.g., SLURM), a distributed memory management system, cluster monitoring tools, and/or other components. In certain implementations, the cluster management system layer may be installed on a designated management management/head compute node (e.g., the primary installation, and potentially on one or more other compute nodes (e.g., client components). According to this arrangement, in certain implementations, an operating scheduler and memory manager exist on each compute node, and high-level cluster scheduling and memory management are handled by additional software layers that coordinate across the compute cluster. In such an example, the local operating system (e.g., on a compute node) may manage node-level compute and memory resources, cluster management software may manage cluster-level resources 3. Both layers work together to provide HPC capabilities

Returning to compilation computing environment 102, compilation computing environment 102 may receive a software application 116, which may be in the form of an uncompiled software application 116a. Uncompiled software application 116a may include source code 118 and one or more memory preference indicators 120. Although illustrated and described separately from source code 118, memory preference indicators 120 may be part of source code 118, separate from source code 118, or a combination of both.

Source code 118 may include human-readable text that forms the basis of software application 116. Written in one or more programming languages, source code 118 may include any suitable combination of statements, declarations, functions, and/or instructions that define how software application 116 should operate when executed. Source code 118 may include any suitable combination of variables to store data, control structures to manage program flow, algorithms to process information, and/or interfaces to handle user interaction. Developers (human or automated) may write source code 118 using specific syntax and programming conventions that conform to the rules of one or more programming languages. The source code serves as a blueprint for the application, containing the logic and functionality for performing the intended tasks of the software application 116.

Source code 118 may be written in any programming language suitable for source code. In certain implementations, source code 118 may be written in a human-readable or other high-level programming language. As just a few examples, source code 118 could be written in any suitable combination of PYTHON, JAVA, C++, C#, JAVASCRIPT, RUBY, PHP, SWIFT, GO (GOLANG), KOTLIN 2, HTML, CSS, TYPESCRIPT, PHP, ASP.NET 3, SQL, PL/SQL, MONGODB QUERY LANGUAGE, R, MATLAB, JULIA, FORTRAN 5, SWIFT (IOS), KOTLIN (ANDROID), JAVA (ANDROID), OBJECTIVE,C (IOS), PERL, SHELL SCRIPT, POWERSHELL, LUA, VBSCRIPT, SCRATCH, ALICE, LOGO 8, HASKELL, SCALA, ERLANG, F#, CLOJURE, COBOL, PASCAL, BASIC, FORTRAN, or any other language suitable for source code.

During execution, a software application such as software application 116 may implement and/or otherwise use one or more data items. As described above, these data items may include program code, data structures, variables, and/or any other suitable types of data items. The operations software application 116 performs with respect to data items may include read operations, write operations, and/or any other suitable types of operations. These operations and details regarding the associated data items may be included throughout source code 118. Some or all of the data items may be used to organize and store data, and may be used to manage data of software application 116, organize information, and facilitate efficient data operations. The choice of data item (e.g., data structure) may affect performance of software application 116, memory usage of memory resources 114, and algorithm efficiency.

In some implementations, a software application 116 may include certain data access patterns and/or data dependencies. These data access patterns and/or data dependencies may be encoded in source code 118 and may be detectible by compiler 106 as part of the analysis associated with compiling uncompiled software application 118a (e.g. compiling source code 118).

Data access patterns may include, for example, read-write access patterns, which may describe how software application 116 accesses and modifies data items in memory resources 114. Example types of data access patterns may include sequential access and random access. Sequential access may include reading/writing data items in consecutive order, which may be common in file processing and/or streaming. A particular example of sequential access may include reading a file from start to finish. Random access may include reading/writing data at arbitrary locations, which may be common in databases or games. A particular example of random access may include accessing scattered array elements. Data access patterns may have certain characteristics, such as frequency (e.g., how often a data item is accessed), locality (e.g., spatial/temporal relationships), direction (e.g., forward or backward), and read-write ratio.

Some particular example data access patterns may include read-heavy access patterns (e.g., mostly reading data items with relatively fewer write operations), an example of which may be web content delivery; write-heavy access patterns (e.g., frequent data item modifications), an example of which may be logging systems; mixed access (e.g., balanced read-write operations), an example of which may be transaction processing; and burst access (e.g., intense activity followed by quiet periods), an example of which may be batch processing. Understanding data access patterns may facilitate performance optimization, memory management, cache design, storage system selection, database optimization, hardware configuration, and/or other objectives.

Data dependencies in a software application 116 may occur when an instruction or operation relies on a data item produced or modified by another instruction. Some example data dependencies may include true dependency, anti-dependency, output dependency, and/or other suitable types of data dependencies. True dependency may include read-after-write in which an instruction is to read a data item that was written by a previous instruction. For example, x=1 may be a first operation and y=x+2 may be a second operation, such that the second operation depends on the first operation. Anti-dependency may include write-after-read in which an instruction writes to a location that was previously read. For example, y=x+2 may be a first operation and x=5 may be a second operation, such that the second operation overwrites a value read by the first operation. Output dependency may include write-after-write in which multiple instructions write to the same location. For example, x=1 may be a first operation and x=5 may be a second operation, such that the second operation overwrites a value written by the first operation. Data dependencies may affect parallelization possibilities, software application optimization, execution order, and/or other aspects of software application design, compilation, and execution.

In certain implementations, data dependencies may play a role in execution of software application 116 and associated management of memory resources 114. In resource allocation, data dependencies may help determine when memory can be safely allocated or released, potentially reducing or eliminating issues like use-after-free errors. For cache coherence, understanding data dependencies may facilitate maintaining consistent data across different cache levels in multi-processor systems. Memory access patterns influenced by data dependencies can inform prefetching strategies and locality optimizations, which may improve performance. During compilation, data dependencies may guide instruction scheduling decisions, where compiler 106 may reorder operations while preserving suitable relationships. Data dependencies may assist in identifying parallelization opportunities by revealing which operations are to execute sequentially and which can potentially run concurrently. In optimizations like loop transformations, register allocation, and dead code elimination, dependency information may help compiler 106 make decisions that preserve semantics of software application 116 while potentially enhancing execution efficiency.

As part of executing software application 116 (e.g., in execution computing environment 104), executing operations relative to data items of software application 116 may impact—potentially significantly—performance of software application 116. Additionally, as described above, memory manager 108 may allocate memory resources 114 to executing instances of software applications 116, including from the heterogeneous types of memory resources 114. Memory manager 108 may use one or more types of memory resources to store and access data items in association with software application execution. The memory resources 114 allocated to particular data items may impact—potentially significantly—performance of software application 116.

According to certain implementations of this disclosure, uncompiled software application 116a may include one or more memory preference indicators 120 for data items associated with software application 116. Memory preference indicators 120 may indicate one or more preferred memory characteristics for storing the data items (e.g., in memory resources 114) in association with execution of the software application 116. For example, memory preference indicators 120 provide a mechanism for a developer of software application 116 to identify preferred values for one or more characteristics of memory resources (e.g., memory resources 114) that are to be allocated for storing data items. In some implementations, source code 118 may include code for multiple data items, and memory preference indicators 120 may indicate a memory placement preference on a data item-by-data item basis.

As just some examples, the one or more preferred memory characteristics indicated by the memory preference indicators 120 may include, for a data item, one or more of a memory type (e.g., processor registers, processor cache, DRAM, NVRAM, flash memory, persistent memory); a latency value (e.g., maximum acceptable latency in nanoseconds, such as 100ns, 300ns, or 1000ns); a memory level of a memory hierarchy that comprises a plurality of memory levels, each memory level of the plurality of memory levels associated with a distinct latency range (e.g., L1 with 1-10ns latency range, L2 with 10-50ns latency range, L3 with 50-100ns latency range); one or more memory bandwidth values (e.g., minimum requested bandwidth in GB/s, such as 10 GB/s, 25 GB/s, or 50 GB/s); a memory location (e.g., on-chip, direct-attached to processor, attached via one switch layer, attached via multiple switch layers, with corresponding physical or logical distances from compute resources 112, or could be characterized as “Local” for data requiring minimal access time, “Shared” for data accessible by multiple processes, “Global” for widely accessible data); a memory security level (e.g., “Secured” for encrypted memory regions, “Standard” for unencrypted regions); and/or any other suitable memory characteristics.

Memory preference indicators 120 may specify one or more of these characteristics to help guide allocation of memory resources 114 for particular data items. For example, a data item that would benefit from fast access and high security might have memory preference indicators 120 specifying both a low latency value (e.g., 100ns maximum) and a secure memory designation. As another example, a data item used for bulk storage might have memory preference indicators 120 specifying a higher acceptable latency (e.g., 1000ns) but also requesting a minimum bandwidth (e.g., 25 GB/s).

In certain implementations, some or all of memory preference indicators 120 may be implemented as compiler directives. It should be understood that source code 118 including memory preference indicators 120 may refer to source code 118 including memory preference indicators 120 within the source code itself, including memory preference indicators 120 in one or more separate files that can be processed by compiler 106 in association with processing (e.g., compiling) source code 118, or providing memory preference indicators 120 in another suitable manner, alone or in combination.

As just a few examples, a compiler directive could be one of the following for specifying local, shared, or global memory: #pragma memory_locality(LOCAL) for data items with minimal latency; #pragma memory_locality(SHARED) for data items that may be accessed by multiple processes; or #pragma memory_locality(GLOBAL) for data items that with broader accessibility. As just a few more example, a compiler directive could specify performance objectives using one of the following: #pragma memory_performance(LATENCY_CRITICAL); or #pragma memory_performance(BANDWIDTH_INTENSIVE). These directives provide the compiler with information to generate appropriate memory allocation metadata. These compiler directives, including their form, format, substance, and the like, are provided as examples only and should not be used to limit this disclosure.

Compiler 106 may receive system configuration information 122. System configuration information 122 may describe various resources of an execution computing environment (e.g., execution computing environment 104) in which software application 116 may be deployed, such as the configuration and capabilities of the execution computing environment. In the illustrated example, system configuration information 122 may describe various resources of execution computing environment 104, such as compute resources 112 and/or memory resources 114. System configuration information 122 may describe the configuration, capabilities, and/or other aspects of execution computing environment 104, such as compute resources 112 and/or memory resources 114.

For example, system configuration information 122 may include respective values for one or more characteristics of execution computing environment 104. In some implementations, the one or more characteristics of system configuration information 122 may include types of the memory resources 114 (e.g., processor registers, processor cache, DRAM, NVRAM, flash memory, persistent memory), locations of memory resources 114 (e.g., on-chip, direct-attached to processor, attached via one switch layer, attached via multiple switch layers, with corresponding physical or logical distances from compute resources 112), capacities of memory resources 114 (e.g., cache sizes such as 32MB L3 cache, DRAM capacity such as 256GB per DIMM, CXL memory capacity such as 2TB per device), interfaces to communicate with memory resources 114 (e.g., DDR5 at 5600 MT/s, PCIe Gen5 x16, CXL 2.0, with corresponding protocol specifications and supported features), speed of memory resources 114 (e.g., latency values such as 100ns for local DRAM or 300ns for CXL memory, bandwidth values such as 50 GB/s for local memory or 32 GB/s for CXL memory), power consumption characteristics (e.g., active power draw such as 20W per DIMM, idle power such as 5W per DIMM); reliability characteristics (e.g., error rates, error correction capabilities); sharing capabilities (e.g., single-user, multi-user, concurrent access limits), and/or any other suitable information.

As a particular example, system configuration information 122 for a particular execution computing environment 104 might indicate availability of 256GB of local DDR5 memory with 100ns latency and 50 GB/s bandwidth, plus 2TB of CXL-attached memory with 300ns latency and 32 GB/s bandwidth. This system configuration information 122 may allow compiler 106 to understand what memory resources 114 are available and their respective capabilities when generating a mapping (e.g., described below with reference to FIG. 1 and as mapping 208, described below with reference to FIG. 2) and memory allocation metadata 126, described below.

Compiler 106 may receive or otherwise access system configuration information 122 in any suitable manner. In certain implementations, some or all of system configuration information 122 may be a database of information that includes data structures and access methods that allow compiler 106 to access the information, potentially without directly probing the hardware, firmware, and/or software of execution computing environment 104. In certain implementations, compiler 106 may directly probe the hardware, firmware, and/or software of execution computing environment 104 to obtain some or all of system configuration information 122 for execution computing environment 104. In certain implementations, compiler 106 provides a user interface via which a user or other entity (e.g., an automated system) may input some or all of system configuration information 122. In certain implementations, an application programming interface (API) or other mechanism could be built that standardizes (formally or de facto) the manner and structure of providing some or all of system configuration information 122 to compiler 106, and compiler 106 may obtain system configuration information 122 via the API or other mechanism.

Compiler 106 may process uncompiled software application 116a to generate compiled software application 116b. For example, compiler 106 may process source code 118 and memory preference indicators 120 of uncompiled software application 116a to generate compiled software application 116b that includes compiled code 124 and memory allocation metadata 126.

As part of generating compiled software application 116b, compiler 106 may compile source code 118 to generate compiled code 124. That is, to generate a version of software application 116 that a computer (e.g., execution computing environment 104) can execute, compiler 106 may compile source code 118 into compiled code 124 of compiled software application 116b. As described briefly above, compiler 106 may be a software tool configured to translate source code 118 written in a high-level programming language into a machine-executable, or binary, code (e.g., object code) of compiled code 124.

In certain implementations, the compilation of source code 118 may include several tasks. For example, compiler 106 may read source code 118 and breaks source code 118 into meaningful tokens through lexical analysis. Compiler 106 may examine these tokens for proper syntax and create an initial internal representation of software application 116, while checking for basic programming errors. Compiler 106 may perform a deep analysis of the code structure of source code 118, converting source code 118 into an intermediate representation that may be optimized for further processing. In certain implementations, as part of the deep analysis, compiler 106 may examine data flow patterns and identify opportunities for improvement, potentially restructuring the code to enhance efficiency while maintaining the original functionality. In a further task, compiler 106 may transform the optimized intermediate representation into machine code specific to the target architecture (e.g., execution computing environment 104). This transformation may involve optimization passes and generation of the executable output (e.g., compiled code 124) that can run on the target system (e.g., execution computing environment 104). The above-described technique for compiling source code 118 into compiled code 124 is just one example technique; this disclosure contemplates compiler 106 compiling source code 118 into compiled code 124 in any suitable manner. Throughout the compilation process, compiler may identify data items, data access patterns, data dependencies, and/or other aspects of software application 116.

Compiler 106 also may analyze source code 118 and system configuration information 122 to determine a mapping of memory resources 114 to the data items associated with software application 116 according to memory preference indicators 120 and system configuration information 122. For example, compiler 106 may compare the preferred memory characteristics for the data items, as provided in the memory preference indicators, to the available memory resources 114 of execution computing environment 104, as determined according to system configuration information 122, to attempt to identify memory resources 114 of execution computing environment that can satisfy the preferred memory characteristics for the data items.

In other words, on a per data item basis, compiler 106 may analyze what memory resources are requested via memory preference indicators 120 and what memory resources 114 actually are available in execution computing environment 104 to generate a mapping describing what memory resources 114 data items of the software application 116 might be allocated during execution in execution computing environment 104. For example, if a first data item has one or more memory preference indicators 120 specifying local memory with maximum latency of 100ns, and system configuration information 122 indicates availability of both DDR5 DIMMs with 80ns latency and CXL memory with 300ns latency, compiler 106 may map the first data item to the DDR5 DIMMs since they satisfy the latency objective. If a second data item has one or more memory preference indicators 120 specifying shared memory with minimum bandwidth of 25 GB/s, and the system configuration information 122 indicates the CXL memory supports 32 GB/s bandwidth with sharing capabilities, compiler 106 may map the second data item to the CXL memory since it satisfies both the bandwidth and sharing objectives. In certain implementations, this comparison may be performed on a data item-by-data item basis.

Thus, factoring in system configuration information 122 as part of generating the mapping of memory resources 114 to data items may allow compiler 106 to generate memory allocation metadata 126 that is particularly applicable to a target execution computing environment 104, which may be an execution computing environment 104 in which software application 116 is expected to execute. It should be understood that compiler 106 may be able to access system configuration information 122 for multiple execution computing environments 104, each with a potentially unique configuration and set of capabilities, and compiler may be able to generate multiple instances of compiled software application 116b that have memory allocation metadata 126 tailored to each of those execution computing environments 104.

In certain implementations, compiler 106 may consider one or more other factors in generating the mapping of memory resources 114 to the data items associated with software application 116. For example, compiler 106 may consider data access patterns for data items, data dependencies between/among data items, or other information determined by or accessible to compiler 106 in determining which memory resources 114 of execution computing environment 104 to map to the data items associated with software application 116. As described above, compiler 106 may have access to or otherwise determine data access patterns for data items associated with software application 116 and/or to data dependencies between/among data items of software application 116. Compiler 106 may determine this information, for example, as part of compiling source code 118. The mapping of memory resources 114 to data items may have any suitable form, according to particular implementations.

Compiler 106 may generate memory allocation metadata 126 according to the mapping of memory resources 114 to the data items associated with software application 116. Memory allocation metadata 126 may include memory placement guidance for the data items. This memory placement guidance may provide instructions to the resource manager of an execution computing environment (e.g., resource manager 107 of execution computing environment 104) to schedule compute resources 112 for execution of software application 116 and to allocate memory resources 114 to data items of software application 116. Although described as guidance, the memory placement guidance in some scenarios may be considered instructions.

In certain implementations, memory allocation metadata 126 may include weight factors for different memory resources 114. These weight factors may reflect the relative desirability of using particular memory resources 114 for specific data items based on factors such as latency, bandwidth, and data access patterns. Compiler 106 may determine appropriate weight factors based on analysis of the data dependencies and data access patterns within the source code 118.

As a particular example, memory allocation metadata 126 and the associated memory placement guidance may be structured to include one or more elements for each data item, such as one or more of: preferred memory locality level (e.g., local, shared, global); expected data access patterns (e.g., read-heavy, write-heavy, mixed); performance objectives (e.g., latency sensitivity, bandwidth objectives); data dependencies with other data items; weight factors for different memory resource types. This example of a structure for memory allocation metadata 126 may allow a resource manager (e.g., resource manager 107) to make informed decisions about memory allocation while maintaining flexibility for different system configurations.

Compiler 106 may generate memory allocation metadata 126 in a format that is understandable to the particular execution computing environment 104 in which software application 116 is to be deployed, which may vary from execution computing environment 104 to execution computing environment 104. For example, compiler 106 may generate memory allocation metadata 126 in a format that is understandable to resource manager 107, which may allow resource manager 107 (e.g., memory manager 108 and scheduler 110) to parse and interpret memory allocation metadata 126.

Compilation computing environment 102 may transmit compiled software application 116b, including compiled code 124 and memory allocation metadata 126, to execution computing environment 104 for execution of software application 116 according to memory allocation metadata 126. Compilation computing environment 102 (e.g., compiler 106) might or might not provide compiled software application 116b directly to execution computing environment 104. In other words, while in some scenarios compilation computing environment 102 (e.g., compiler 106) might provide compiled software application 116b directly to execution computing environment 104, in some scenarios one or more other entities might provide compiled software application 116b to execution computing environment 104.

Execution computing environment 104 may obtain compiled software application 116b, including compiled code 124 and memory allocation metadata 126. As described above, memory allocation metadata 126 may include memory placement guidance for allocating memory resources 114 to data items of software application 116. Additionally, as described above, in some implementations, the memory placement guidance was determined according to memory preference indicators included in source code 118 of software application 116 (e.g., uncompiled software application 116a).

As part of executing software application 116, resource manager 107 (e.g., memory manager 108) may determine available memory resources 114 to be allocated to data items of software application 116. Resource manager 107 (e.g., memory manager 108) may allocate memory resources 114 of the determined available memory resources 114 to the data items of software application 116 according to memory placement guidance of memory allocation metadata 126. In certain implementations, resource manager 107 (e.g., scheduler 110) may schedule execution of software application 116 using compute resource 112, in a manner that attempts to accommodate information learned from memory allocation metadata 126.

As described above, in certain implementations, memory allocation metadata 126 may include weight factors for different memory resources 114. Resource manager 107 may use these weight factors when determining how to allocate memory resources 114. For example, data items with higher weight factors for local memory resources 114 may be preferentially allocated to local memory resources 114 when available.

Execution computing environment 104 may execute the compiled code 124 of compiled software application 116b to run software application 116 according to the allocation of the available memory resources 114 to the data items of software application 116. For example, execution computing environment 104 may cause compute resources 112 of execution computing environment 104 to execute the compiled code 124 of compiled software application 116b to run software application 116 according to the allocation of the available memory resources 114 to the data items of software application 116.

Although illustrated separately, in certain implementations, compilation computing environment 102 and execution computing environment 104 may overlap, in whole or in part. For example, source code 118 for software application 116 (e.g., of uncompiled software application 116a) may be compiled in the same computer system in which the software application 116 (e.g., compiled software application 116b) is or will be executed. In certain implementations, [compiler could be just-in-time (JIT) compiler that compiles code in the execution (e.g., run-time) environment during execution of the application.]

In the illustrated example, compilation computing environment 102 includes processor 200, communication controller 202, and memory 204. Although described in the singular for ease of description, compilation computing environment 102 may include one or more processors 200, one or more communication controllers 202, and one or more memories 204.

Processor 200 may be any component or collection of components adapted to perform computations and/or other processing-related tasks. Processor 200 can be, for example, a microprocessor, a microcontroller, a control circuit, a digital signal processor, an FPGA, an ASIC, a system-on-chip (SoC), or combinations thereof. Processor 200 may include any suitable number of processors, or multiple processors may collectively form a single processor 200.

Communication controller 202 represents any suitable computer element that can receive information from a communication link, transmit information through a communication link, perform suitable processing of the information, communicate to other components, or any combination of the preceding. The communication link could be a direct link to another computing component, a link to a communication network, such as the internet, a high-speed link to a switch fabric (e.g., INFINIBAND, CXL, etc.), or any other suitable type of communication link. Communication controller 202 represents any port or connection, real or virtual, including any suitable combination of hardware, firmware, and software, including protocol conversion and data processing capabilities, to communicate through a local area network (LAN), wide area network (WAN), or other communication system that allows information to be exchanged. Communication controller 202 may facilitate wireless and/or wired communication. Communication controller 202 may facilitate the receipt and/or communication of source code 118, memory preference indicators 120, system configuration information 122, compiled code 124, and/or memory allocation metadata 126.

Memory 204 may include any suitable combination of volatile memory, non-volatile memory, and/or virtualizations thereof. For example, memory may include any suitable combination of magnetic media, optical media, RAM, ROM, removable media, and/or any other suitable memory component. Memory 204 may include data structures used to organize and store all or a portion of the stored data.

In the illustrated example, memory 204 stores compiler instructions 206, source code 118, memory preference indicators 120, system configuration information 122, compiled code 124, a mapping 208 of memory resources 114 to data items of software application 116, and memory allocation metadata 126. Compiler instructions 206 may include the logic for compiler 106 of FIG. 1, including the logic that when executed causes compilation computing environment 102 (e.g., processor 200) to perform the operations of compiler 106 of FIG. 1.

At least a portion of memory 204 may be considered a computer-readable medium on which computer code (e.g., compiler instructions 206) is stored. References to computer-readable medium, computer-readable storage medium, computer program product, tangibly embodied computer program, or the like, or a controller, circuitry, computer, processor, or the like should be understood to encompass not only computers having different architectures such as single or multi-processor architectures and sequential (Von Neumann) or parallel architectures but also specialized circuits such as FPGAs, ASICs, signal processing devices, and other devices. References to computer program, instructions, logic, code, or the like, should be understood to encompass software for a programmable processor or firmware such as, for example, the programmable content of a hardware device whether instructions for a processor, or configuration settings for a fixed-function device, gate array or programmable logic device, or the like.

Source code 118, memory preference indicators, system configuration information 122, compiled code 124, mapping 208, and memory allocation metadata 126 are described in detail elsewhere in this disclosure, including with reference to FIG. 1. Source code 118 and memory preference indicators 120 may be associated with a software application 116, and particularly with uncompiled software application 116a.

Compiler computing environment 102 may include source code 118, memory preference indicators, system configuration information 122, compiled code 124, mapping 208, and memory allocation metadata 126 for multiple different software applications 116. Compiler computing environment 102 may store instances of system configuration information 122 for multiple different execution computing environments 104, if appropriate, each with a potentially unique configuration and set of capabilities as reflected in the respective system configuration information 122. Using the different instances of system configuration information 122, compiler computing environment 102 (e.g., compiler 106, as implemented using compiler instructions 206) may be able to generate multiple instances of compiled software application 116b that have memory allocation metadata 126 tailored to each of those execution computing environments 104.

Mapping 208 may represent a determination by compiler 106 of which memory resources 114 may be used for which data items of software application 116. For example, mapping 208 may include entries that associate each data item with one or more characteristics of memory resources 114 that would be suitable for storing that data item. The characteristics could include memory type, memory level of a memory hierarchy, latency values or ranges, location information, or other suitable characteristics. In certain implementations, compiler 106 may generate mapping 208 by analyzing the memory preference indicators 120 to determine what type of memory resource 114 is requested (e.g., as reflected in memory preference indicators 120) for particular data items, analyzing system configuration information 122 to determine what memory resources 114 are actually available in execution computing environment 104, and then determining which available memory resources 114 best satisfy the preferences indicated in memory preference indicators 120. Compiler 106 may also consider data dependencies and memory access patterns identified during compilation when generating mapping 208. For example, data items with dependencies may be mapped to memory resources 114 with similar characteristics (e.g., similar latency values) to help promote consistent access times. As another example, data items with heavy read/write patterns may be mapped to memory resources 114 that perform well with mixed read/write operations, such as CXL memory resources, while data items with primarily read operations may be mapped to memory resources 114 that are optimized for read operations, such as DDR memory resources. Mapping 208 may be an intermediate representation that compiler 106 uses to generate memory allocation metadata 126, and might or might not be stored persistently.

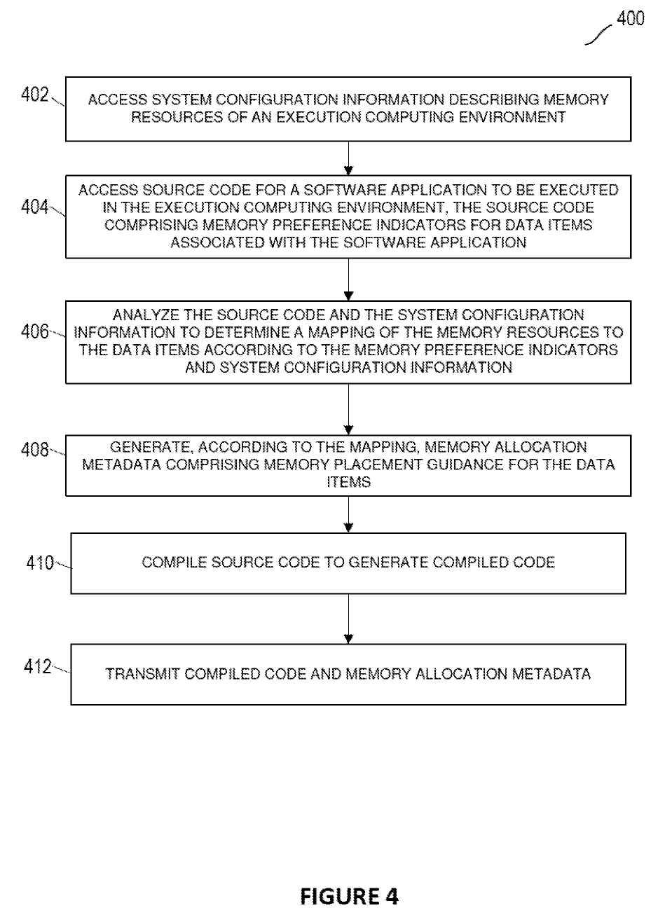

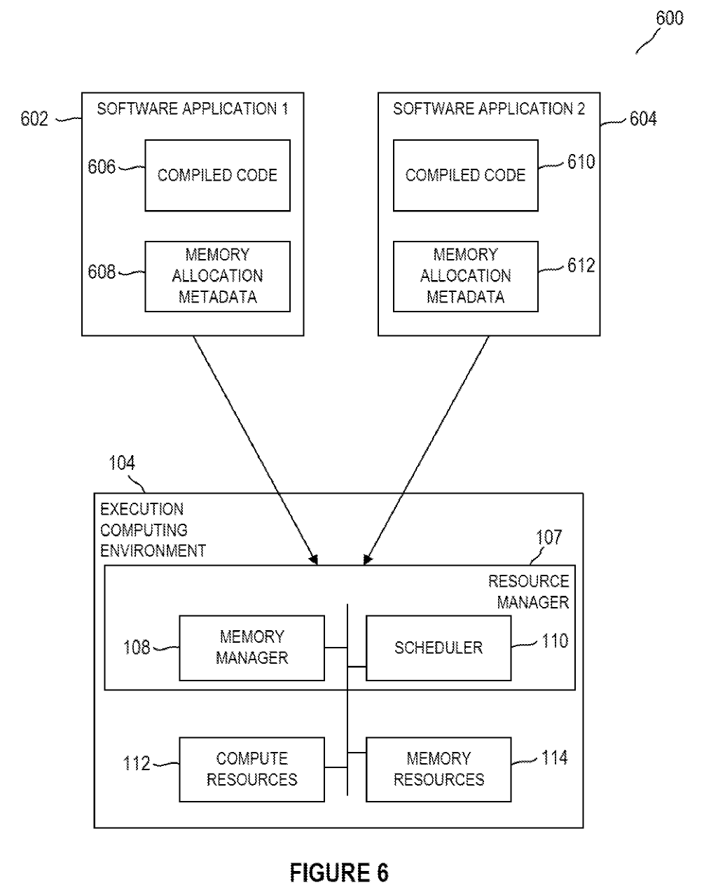

In operation of an example implementation of compilation computing environment 102, compiler instructions 206 may execute processes in the manner described above in connection with FIG. 1 and below in connection with FIGS. 4 and 6. The descriptions of FIGS. 1, 4, and 6, are incorporated into the description of FIG. 2 by reference.

In certain implementations, compute nodes 300 may work together to perform processing operations, such as cluster operations, HPC operations, and/or other suitable types of computing operations. For example, a workload may be divided into smaller segments or tasks that may be parallelized across compute nodes 300. Process(es), such as execution of some or all of a software application 116, may be executed on compute nodes 300 to perform the processing operations associated with the workload. Compute nodes 300 may be implemented using any suitable combination of hardware, firmware, and software. For example, each compute node 300 may be a standalone unit equipped with a processor, memory, and the like (subsequently described). Although FIG. 3 shows a particular number of compute nodes 300, execution computing environment 104 may include any suitable number of compute nodes 300.

A workload, which also may be referred to as a computing workload, may include a collection of one or more electronic processing tasks organized in any suitable manner. For example, a workload may include, or be a portion of, one or more software applications 116. A workload may be executed using one or more compute nodes 300, which execute processing tasks, such as tasks of a workload for execution in a potentially parallel manner. For example, these processing tasks may be assigned to compute nodes 300 as execution flows that involve compute nodes 300 executing computer code, potentially in portions. To that end, compute nodes 300 may execute one or more processes of the workload, working together to execute the workload.

Processor 306 (referred to, for simplicity, in the singular) may retrieve and execute executable code. The executable code may, when executed by processor 306, cause processor 306 to implement any functionality of the code being executed. Processor 306 may be a microprocessor, an ASIC, a microcontroller, or the like. In certain implementations, processor 306 may be a central processing unit (CPU). Although referred to in the singular, processor 306 may be multiple processors at one or more locations.

In certain implementations, processor 306 includes memory resources 314. Memory resources 314 may include registers and/or cache memory, such as L1, L2, L3, and/or L4 caches. Memory resources 314 may be part of memory resources 114 of FIG. 1.

Memory resources 308a and 308b, referred to collectively as memory resources 308, may be any suitable type or combination of types of storage, including, for example, any suitable combination of volatile memory, non-volatile memory, and/or virtualizations thereof. For example, memory may include any suitable combination of magnetic media, optical media, RAM, ROM, removable media, and/or any other suitable memory component. Memory resources 308a and 308b may include data structures used to organize and store all or a portion of the stored data. In general, memory resources 308a and 308b can store, at least in part, any data used by or accessible to processor 306. Particular examples of memory resources 308 may include DAS, RAM, DIMMs (e.g., that include RAM), accelerators (e.g., that include their own device memory, such as RAM), and/or other suitable types of memory.

Memory 310 may include various types of memory, including volatile and nonvolatile memory. For example, memory 310 may include RAM, ROM, an HDD, an SSD or other flash memory, and/or the like. Different types of memory may be used for different data storage needs. For example, processor 306 may boot from ROM, maintain nonvolatile storage in an HDD, execute program code stored in RAM, and store data under processing in RAM. In certain implementations, a portion or all of memory 310 may be or include a database, such as one or more structured query language (SQL) servers or relational databases. Memory 310 may include a non-transitory computer readable medium that stores instructions for execution by processor 306. One or more modules within compute node 300a may be partially or wholly embodied as software and/or hardware for performing any functionality described herein. Although referred to in the singular, memory 310 may be multiple memory devices at one or more locations.

Memory 310 may store operating system 316, compiled code 124 and memory allocation metadata 126. Operating system 316 may include software that manages computer hardware and software resources while providing common services for software applications. Operating system 316 may act as an intermediary between computer hardware and a user (human or otherwise).

Operating system 316 may include resource manager instructions 317, which may implement resource manager 107 of FIG. 1. Resource manager instructions 317 may be configured to perform, when executed, the operations of resource manager 107 of FIG. 1, such as coordinating access to the computer system’s physical resources like processor 306 (and/or other compute resources 112 of FIG. 1), memory resources (e.g., memory resources 304, memory resources 308, memory 310, memory resources 314, and/or other memory resources 114 of FIG. 1), storage (e.g., some or all of memory 310), and input/output devices. Operating system 316 may provide an interface that allows users and software applications to interact with computer hardware through standardized system calls and services, creating a stable, efficient, and secure computing environment. Operating system 316 may include any suitable type of operating system, such as a LINUX operating system (e.g., UBUNTU, DEBIAN, CENTOS, FEDORA, etc.) or any other suitable type of operating system 316.

Resource manager instructions 317 may include memory manager instructions 318 and scheduler instructions 320. Memory manager instructions 318, may be configured to perform, when executed, the operations of memory manager 108 of FIG. 1. Scheduler instructions 320 may be configured to perform, when executed, the operations of scheduler 110 of FIG. 1.

Memory 310 may store compiled code 124 and associated memory allocation metadata 126 for one or more software applications (e.g., software application 116 of FIG. 1). Compiled code 124 and associated memory allocation metadata 126 may be received (e.g., via communication controller 312, described below) from compilation computing environment 102 of FIGS. 1-2 or another suitable entity.

Compute nodes 300 may communicate with memory resources 304 via communication network 302. Communication network 302 facilitates wireless and/or or wireline communication. Communication network 302 may communicate, for example, IP packets, Frame Relay frames, ATM cells, voice, video, data, and other suitable information between network addresses. Communication network 302 may include any suitable combination of one or more LANs, radio access networks (RANs), metropolitan area networks (MANs), WANs, mobile networks (e.g., using WiMax (802.16), WiFi (802.11), 3G, 4G, 5G (and beyond), or any other suitable wireless technologies in any suitable combination), all or a portion of the global computer network known as the Internet, and/or any other communication system or systems at one or more locations, any of which may be any suitable combination of wireless and wireline. In certain implementations, at least a portion of communication network 302 is a high-speed interconnect, such as one or more INFINIBAND network or a CXL network.

Memory resources 304a through 304d, which may be referred to generally as memory resources 304, may include memory resources that may be shared among or otherwise accessible to one or more of compute nodes 300. Memory resources 304 may be part of memory resources 114 of FIG. 1. Although FIG. 3 shows execution computing environment including a particular number of memory resources 304, execution computing environment 104 may include any suitable number of memory resources 304.

Memory resources 304 may include may include any suitable type or combination of types of storage, including, for example, any suitable combination of volatile memory, non-volatile memory, and/or virtualizations thereof. For example, memory may include any suitable combination of magnetic media, optical media, RAM, ROM, removable media, and/or any other suitable memory component. Memory resources 304 may include data structures used to organize and store all or a portion of the stored data. In general, memory resources 304 can store, at least in part, any data used by or accessible to compute nodes 300, including processors 306 of compute nodes 300.

Particular examples of memory resources 304 may include DAS, RAM, DIMMs (e.g., that include RAM), accelerators (e.g., GPU devices, ASIC devices, FPGA devices, and VPU devices, and/or other types of hardware devices that include their own device memory, such as RAM), and/or other suitable types of memory devices. In certain implementations, one or more of memory resources 304 may be compute-capable storage devices, which may be referred to as smart storage devices, may include a flash storage device (e.g., potentially including an array of coupled flash storage devices) with a locally coupled processor (e.g., an ASIC, FPGA, or other type of processing device). Some compute-capable storage devices are referred to as computational storage devices. In a particular example, at least a portion of communication network 302 implements a CXL switch fabric (or other high-speed switch fabric) of zero or more layers, and some or all of memory resources 304 may be memory devices connected via the CXL switch fabric.

Memory resources 304, memory resources 308, memory 310, and memory resources 314 may be heterogeneous. For example, memory resources 304, memory resources 308, memory 310, and memory resources 314 may have varying characteristics that can lead to different latency and bandwidth performance. For example, memory resources 304 may include different types of memory attached via one or more layers of a switch fabric (e.g., a portion of communication network 302), such as CXL memory devices arranged in multiple tiers with different latency characteristics based on their position in the fabric hierarchy. Memory resources 308 may include RAM, DAS, or another type of memory coupled to processor 306, such as DDR5 DIMMs installed in memory slots on a motherboard containing processor 306. Memory 310 may include storage devices such as SSDs, HDDs, RAM, or other memory components that provide larger capacity but potentially slower access times than memory resources closer to processor 306. Memory resources 314 may include on-chip storage, such as processor registers and cache memory (e.g., one or more cache layers implemented using on-chip RAM), which provide the fastest access times but with limited capacity. These different memory resources may be organized in a hierarchy based on their performance characteristics, with on-chip storage providing the lowest latency but smallest capacity, local attached memory providing moderate latency and capacity, and fabric-attached memory providing the highest capacity but also higher latency.

Returning to compute node 300a, compute node 300a may receive compiled code 124 and associated memory allocation metadata 126 (e.g., compiled software application 116b of FIG. 1). The compiled code 124 and associated memory allocation metadata 126 may have been generated by a compiler (e.g., compiler 106).

As described above with reference to FIG. 1, a software application 116 may generate or otherwise interacting with one or more data items 322, labeled as data items 322a, 322b, and 322c, which may be referred to generally as data item 322 or data items 322. Although FIG. 3 shows a particular number of data items 322, this disclosure contemplates a software application 116 generating or otherwise interacting with any suitable number of data items 322.

Memory allocation metadata 126 may include memory preference guidance that resource manager 107 (as implemented by resource manager instructions 317) can use to guide allocation of memory resources 304, memory resources 308, memory 310, and memory resources 314 (or other memory resources 114) to data items 322 associated with an executing software application 116. Additional details regarding memory allocation metadata 126 are described above with reference to FIG. 1.

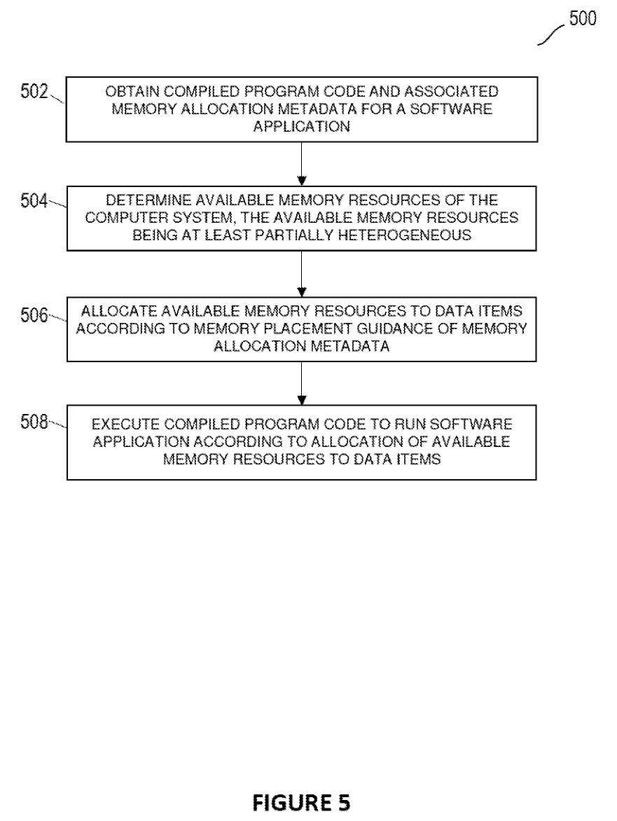

In operation of an example implementation of execution computing environment 104, resource manager instructions 317 (e.g., memory manager instructions 318 and scheduler instructions 320) may execute processes in the manner described above in connection with FIG. 1 and below in connection with FIGS. 5-6, such as for resource manager 117 (e.g., memory manager instructions 318 and scheduler instructions 320). The descriptions of FIGS. 1 and 5-6 are incorporated into the description of FIG. 3 by reference.

In the illustrated example, execution of resource manager instructions 317 (e.g., memory manager instructions 318) by processor 306 has caused data item 322a to be allocated memory in memory resource 308b, data item 322b to be allocated memory in memory resource 304a, and data item 322c to be allocated memory in memory resource 304c. For example, execution of resource manager instructions 317 (e.g., memory manager instructions 318) by processor 306 has caused data item 322a to be placed in memory resource 308b, data item 322b to be placed in memory resource 304a, and data item 322c to be placed in memory resource 304c. To the extent possible, resource manager instructions 317 (e.g., memory manager instructions 318) when executed by processor 306 may have determined these allocations according to memory allocation metadata 126 and the associated memory placement guidance for data items 322a, 322b, and 322c.

FIG. 4 illustrates an example method 400 for managing memory resource allocation for software applications, according to certain implementations. In certain implementations, some or all of the operations associated with method 400 are performed by compilation computing environment 102 of FIG. 1. For purposes of this example, the steps of method 400 are described as being performed by compiler 106 of FIG. 1.

At step 402, compiler 106 may access system configuration information 122, which, as described above, may describe various resources of an execution computing environment 104. For example, system configuration information 122 may describe compute resources 112 and/or memory resources 114 of execution computing environment 104. In this example, memory resources 114 of execution computing environment 104 are at least partially heterogeneous. In some implementations, system configuration information 122 may include information indicating one or more of types of the memory resources 114, locations of memory resources 114, capacities of memory resources 114, interfaces to communicate with memory resources 114, speed of memory resources 114, and/or any other suitable information.

In certain implementations, memory resources 114 may correspond to a memory hierarchy that includes multiple levels. Each memory resource 114 may correspond to a level of the memory hierarchy. Each level of the memory hierarchy may be associated with a corresponding range of latency values. In certain implementations, memory resources 114 include local memory and fabric-attached memory. As described above, in certain implementations, the fabric-attached memory may be implemented at least partially using CXL, and the memory resources 114 attached via the fabric-attached memory (e.g., some or all of memory resources 304 of FIG. 3) may include memory devices arranged in zero or more tiers. At least some of memory resources may have different latency and/or bandwidth characteristics from one another. For example, a first memory resource 114 could have a first latency, and a second memory resource 114 could have a different second latency (e.g., a slower response time than the first memory resource).

At step 404, compiler 106 may access source code 118 for a software application 116 to be executed in execution computing environment 104. For example, compiler may access uncompiled software application 116a. Source code 118 may include memory preference indicators 120 for data items associated with software application 116. Data items associated with a software application 116 (e.g., as reflected in source code 118, and ultimately in compiled code 124 for the software application 116) may include program code, data structures, variables, and/or any other suitable types of data items.

Memory preference indicators 120 may indicate one or more preferred memory characteristics for storing the data items in association with execution of software application 116. In certain implementations, some or all of memory preference indicators 120 may be implemented as compiler directives. As just some examples, the one or more preferred memory characteristics indicated by the memory preference indicators 120 may include, for a data item, one or more of a memory type; a memory level of a memory hierarchy that comprises a plurality of memory levels, each memory level of the plurality of memory levels associated with a distinct latency range; one or more memory latency values; a memory location; a memory security level; and/or any other suitable memory characteristics. Some or all of the memory preference indicators 120 may specify different memory characteristics (e.g., different memory levels) for different data items (e.g., data items 322). For example, a first memory preference indicator 120 may specify a first memory level for a first data item, and a second memory preference indicator 120 may specify a different second memory level for a second data item.

At step 406, compiler 106 may analyze source code 118 and system configuration information 122 to determine a mapping (e.g., mapping 208 of FIG. 2) of memory resources 114 to the data items according to memory preference indicators 120 and system configuration information 122. Additional details regarding determination of the mapping (e.g., mapping 208) are described above with reference to FIGS. 1 and 2.

In certain implementations, compiler 106 is configured to analyze source code 118 to determine data dependencies within source code 118 and to determine memory access patterns within source code 118. In certain implementations, compiler 106 may perform this analysis as part of the analysis at step 406 or as part of compiling source code 118 (described below with reference to step 410), steps that might overlap or be reordered.

In certain implementations, compiler 106 may determine data dependencies by performing a process called “dependence analysis” in which compiler 106 examines the instructions in source code 118 to identify which instructions are to be executed in a specific order because those instructions rely on results of previous instructions that modify shared data items, effectively creating a data flow between them. This data dependency information may be useful for optimizing instruction scheduling and parallelization for software application 116. Although this disclosure contemplates compiler 106 using any suitable type of dependence analysis technique (or combination of types of dependency analysis techniques), a few dependence analysis techniques include data flow analysis, dependence graphs, and alias analysis. With data flow analysis, compiler 106 may track the propagation of values through program paths, potentially facilitating optimizations like constant propagation and dead code elimination. With dependence graphs, compiler 106 may create visual representations of relationships between operations, with nodes representing statements and edges showing dependencies, potentially facilitating compiler optimizations and parallelization opportunities. With alias analysis, compiler 106 may determine when different variable names might reference the same memory location, which may help accurately identify dependencies in programs using pointers or references.

The memory access patterns may include, for example, read-write access patterns, which may describe how software application 116 accesses and modifies data items (e.g., data items 322) in memory resources 114. Example data access patterns are described elsewhere in this disclosure. In certain implementations, compiler 106 analyzing source code 118 and system configuration information 122 to determine a mapping (e.g., mapping 208 of FIG. 2) of memory resources 114 to the data items (e.g., data items 322) includes analyzing the data dependencies and the memory access patterns within source code 118 to determine the mapping (e.g., mapping 208 of FIG. 2).

At step 408, compiler 106 may generate, according to mapping 208, memory allocation metadata 126. Memory allocation metadata 126 may include memory placement guidance for the data items. For example, the memory placement guidance may include memory placement instructions that instruct a resource manager or other suitable component of an execution computing environment 104 of what memory to allocate to particular data items of software application 116. In some implementations, compiler 106 may have considered data dependencies and memory access patterns of software application 116 in generating mapping 208, and thus memory allocation metadata 126 may reflect the determinations related to data dependencies and memory access patterns of software application 116. Additional details regarding memory allocation metadata 126 and associated memory placement guidance are described elsewhere in this disclosure.

At step 410, compiler 106 may compile source code 118 to generate compiled code 124. For example, compiler 106 may parse and analyze source code 118 as part of compiling source code 118, and based on the parsing and analysis, compiler 106 may generate compiled code 124. Compiled code 124 may be executable code for the software application 116.

It should be understood that steps 406, 408, and 410 could be reordered or merged in any suitable manner. For example, the analysis performed at step 406 could be performed as part of compiling source code 118 at step 410. As another example, the compiled code 124 could be generated prior to or at the same time as memory allocation metadata 126 is generated. Furthermore, as described above, memory allocation metadata 126 could be included as part of compiled code 124, generated as a separate file to compiled code 124, and/or provided in any other suitable manner.

At step 412, compiler 106 may transmit compiled code 124 and memory allocation metadata 12 to a resource manager of an execution computing environment in which software application 116 is to be executed (e.g., resource manager 107 of execution computing environment 104). For example, compiler 106 may transmit a compiled software application 116b that includes compiled code 124 and memory allocation metadata 126 to resource manager 107 of execution computing environment 104 for execution of software application 116 according to memory allocation metadata 126.

FIG. 5 illustrates an example method 500 for managing memory resource allocation for software applications, according to certain implementations. In certain implementations, some or all of the operations associated with method 500 are performed by execution computing environment 104 of FIG. 1. For purposes of this example, the steps of method 500 are described as being performed by resource manager 107, which may include being performed by memory manager 108 and/or scheduler 110 of FIG. 1. Resource manager 107 may be part of an operating system (e.g., operating system 316) deployed in execution computing environment 104.

At step 502, resource manager 107 may obtain compiled code 124 and associated memory allocation metadata 126 for a software application 116. For example, resource manager 107 may receive a compiled software application 116b that includes compiled code 124 and memory allocation metadata 126 for execution of software application 116 according to memory allocation metadata 126. Memory allocation metadata 126 may include memory placement guidance for allocating memory resources 114 (e.g., of execution computing environment 104) to data items of software application 116. For example, the memory placement guidance may include memory placement instructions that instruct a resource manager or other suitable component of an execution computing environment 104 of what memory to allocate to particular data items of software application 116. The memory placement guidance may have been determined (e.g., by compiler 106 of compilation computing environment 102) according to memory preference indicators 120 included in source code 118 of software application 116.

At step 504, resource manager 107 may determine available memory resources 114 of execution computing environment 104. For example, resource manager 107 may query hardware interfaces (e.g., SMBIOS tables, PCIe configuration space, CXL device registers) to discover installed memory devices and their characteristics. Resource manager 107 may also track current allocation status of memory resources 114, including which portions are already allocated to other software applications and which portions remain available. For memory resources 114 that are shared, resource manager 107 may determine current usage levels and available bandwidth. The available memory resources 114 may be at least partially heterogeneous.

At step 506, resource manager 107 may allocate memory resources 114 of the available memory resources 114 to the data items of software application 116 according to the memory placement guidance of memory allocation metadata 126. For example, resource manager 107 may parse memory allocation metadata 126 to identify, for each data item, what type of memory resource 114 is requested for that data item. Resource manager 107 may then compare those objectives to the available memory resources 114 determined at step 504 to identify suitable memory resources 114 that satisfy the objectives. When multiple suitable memory resources 114 are available for a particular data item, resource manager 107 may select among the suitable memory resources 114 based on factors such as current load balancing, power consumption objectives, or other system management considerations. Resource manager 107 may update its internal records to reflect the new allocations and configure appropriate page tables or other memory management data structures to allow software application 116 to access the allocated memory resources 114.

At step 508, resource manager 107 may execute compiled code 124 to run software application 116 according to the allocation of the available memory resources 114 to the data items of software application 116. For example, resource manager 107 may initialize the allocated memory resources 114, set up appropriate memory mappings and access permissions, and begin execution of the software application 116 using compute resources 112. During execution, when software application 116 performs memory operations (e.g., read operations, write operations) on its data items, those operations may be directed to the specific memory resources 114 that were allocated for those data items according to memory allocation metadata 126. This may allow software application 116 to take advantage of the heterogeneous memory resources 114 in a manner aligned with the preferences specified in the original source code 118 (e.g., via the memory preference indicators 120), while accounting for the actual memory resources 114 available in execution computing environment 104. In certain implementations, resource manager 107 may monitor the execution and memory usage patterns of software application 116 to help ensure the allocations continue to provide expected performance.

In some scenarios of method 500, memory allocation metadata 126 for a software application 116 may include different memory placement instructions for different data items (e.g., data items 322 of FIG. 3) of software application 116. For example, memory guidance of memory allocation metadata 126 may include first memory placement instructions for a first data item (e.g., a first data item 322 of FIG. 3) of software application 116 and second memory placement instructions for a second data item (e.g., a second data item 322 of FIG. 3) of software application 116. The first memory placement instructions may indicate a first memory level for the first data item, and the second memory placement instructions indicate a different second memory level for the second data item. At step 506, resource manager 107 may allocate memory resources 114 that are at the first memory level for the first data item of software application 116 and that are at the second memory level for the second data item of software application 116.

FIG. 6 illustrates an example scenario 600 of managing memory resource allocation for multiple software applications for execution by an execution computing environment, according to certain implementations. In the illustrated example, execution computing environment 104 receives a first compiled software application 602 (shown as software application 1) and a second compiled software application 604 (shown as software application 2). Software applications 602 and 604 may be examples of software application 116 described with reference to FIG. 1. In particular, software applications 602 and 604 may be examples of compiled software application 116b of FIG. 1.

As shown in FIG. 6, software application 602 includes compiled code 606 and memory allocation metadata 608, and software application 604 includes compiled code 610 and memory allocation metadata 612. Compiled code 606 and compiled code 610 may be analogous to compiled code 124 of FIG. 1. Memory allocation metadata 608 and memory allocation metadata 612 may be analogous to memory allocation metadata 126 of FIG. 1.

A compiler analogous to compiler 106 of FIG. 1 may have generated a compiled (e.g., executable) version of software application 602 using source code for software application 602 and system configuration information (e.g., system configuration information 122) for the execution computing environment in which software application 602 is expected to run (e.g., execution computing environment 104), resulting in compiled code 606 and memory allocation metadata 608. The same or a different compiler (e.g., also analogous to compiler 106 of FIG. 1) may have generated a compiled (e.g., executable) version of software application 604 using source code for software application 604 and system configuration information (e.g., system configuration information 122) for the execution computing environment in which software application 602 is expected to run (e.g., execution computing environment 104), resulting in compiled code 610 and memory allocation metadata 612.

For purposes of this example, it will be assumed that execution computing environment 104 receives both software application 602 and software application 604 for execution during at least a partially overlapping time period. Resource manager 107 of execution computing environment 104 may coordinate execution of software application 602 and software application 604 in a manner that attempts to efficiently use compute resources 112 and memory resources 114. In certain implementations, the information included in memory allocation metadata 608 and memory allocation metadata 612 may improve the ability of resource manager 107 to coordinate execution of software application 602 and software application 604 in a manner that attempts to efficiently use compute resources 112 and memory resources 114. Scheduler 110 may schedule compute resources 112 in a manner that accommodates both execution of software application 602 and execution of software application 604. Memory manager 108 may allocate memory resources 114 in a manner that accommodates both software application 602 and software application 604.

In operation of an example implementation of scenario 600, resource manager 107 may obtain compiled code 606 and associated memory allocation metadata 608 for software application 602, and may obtain compiled code 610 and associated memory allocation metadata 612 for software application 604. Memory allocation metadata 608 for software application 602 may include first memory placement guidance for allocating memory resources 114 to data items (e.g., data items 322 of FIG. 3) of software application 602. Memory allocation metadata 612 for software application 604 may include second memory placement guidance for allocating memory resources 114 to data items (e.g., data items 322 of FIG. 3) of software application 604. A compiler (e.g., compiler 106) may have determined the first memory placement guidance according to memory preference indicators included in source code for software application 602 (e.g., analogous to memory preference indicators 120 included in source code 118 of uncompiled software application 116a of FIG. 1), and may have determined the second memory placement guidance according to second memory preference indicators included in source code for software application 604 (e.g. analogous to memory preference indicators 120 included in source code 118 of uncompiled software application 116a of FIG. 1).

Continuing with this example, resource manager 107 may determine available memory resources 114 of the execution computing environment 104. Resource manager 107 may allocate the available memory resources 114 to the data items (e.g., data items 322 of FIG. 3) of software application 602 according to the memory placement guidance of memory allocation metadata 1608 for software application 602, and may allocate the available memory resources 114 to the data items (e.g., data items 322 of FIG. 3) of software application 604 according to the memory placement guidance of memory allocation metadata 612 for software application 604. Resource manager 107 may execute compiled code 606 of software application 602 to run software application 602 according to the allocation of the available memory resources 114 to the data items (e.g., data items 322 of FIG. 3) of software application 602. Resource manager 107 also may execute the second compiled code 610 to run software application 604 according to the allocation of the available memory resources 114 to the data items (e.g., data items 322 of FIG. 3) of software application 604.

For example, resource manager 107 (e.g., scheduler 110) may analyze memory allocation metadata for multiple applications (e.g., memory allocation metadata 608 and memory allocation metadata 612) to identify complementary data access patterns. For example, when two software applications (e.g., software application 602 and software application 604) are scheduled to execute concurrently, resource manager 107 (e.g., scheduler 110) may examine the respective read/write patterns as indicated in their respective memory allocation metadata (e.g., memory allocation metadata 608 and memory allocation metadata 612). If one software application is primarily read-intensive while another software application has balanced read/write operations, resource manager 107 (e.g., scheduler 110) may co-locate at least some data items for these software applications to optimize utilization of memory resources 114 with different read/write performance characteristics. This can lead to better overall system performance by matching behavior of software applications to memory resource capabilities.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A computer system, comprising:
one or more processors; and
one or more non-transitory computer-readable storage media storing programming for execution by the one or more processors, the programming comprising instructions to:
access system configuration information describing memory resources of an execution computing environment, the memory resources being at least partially heterogeneous;
access source code for a software application to be executed in the execution computing environment, the source code comprising memory preference indicators for data items associated with the software application, the memory preference indicators indicating one or more preferred memory characteristics for storing the data items in association with execution of the software application;
analyze the source code and the system configuration information to determine a mapping of the memory resources to the data items according to the memory preference indicators and system configuration information; and
generate, according to the mapping, memory allocation metadata comprising memory placement guidance for the data items.

2. The computer system of claim 1, wherein the system configuration information comprises one or more of:
types of the memory resources;
locations of the memory resources;
capacities of the memory resources;
interfaces to communicate with the memory resources; or
speed of the memory resources.

3. The computer system of claim 1, wherein the memory preference indicators comprise compiler directives.

4. The computer system of claim 1, wherein, for each data item of the data items, the one or more preferred memory characteristics indicated by the memory preference indicators comprise one or more of:
a memory type;
a memory level of a memory hierarchy that comprises a plurality of memory levels, each memory level of the plurality of memory levels associated with a distinct latency range;
one or more memory latency values;
a memory location; or
a memory security level.

5. The computer system of claim 1, wherein:
the programming further comprises instructions to:
determine data dependencies within the source code; and
determine memory access patterns within the source code; and
analyzing the source code and the system configuration information to determine a mapping of the memory resources to the data items according to the memory preference indicators and system configuration information comprises analyzing the data dependencies and the memory access patterns within the source code to determine the mapping of the memory resources to the data items.

6. The computer system of claim 1, wherein the memory resources correspond to a memory hierarchy that comprises a plurality of levels, each level of the plurality of levels being associated with a corresponding range of latency values, each memory resource of the memory resources corresponding to a level of the memory hierarchy.

7. The computer system of claim 1, wherein the data items comprise a plurality of data structures.

8. The computer system of claim 1, wherein:
the data items comprise a first data item and a second data item;
the memory preference indicators comprise a first memory preference indicator for the first data item and a second memory preference indicator for the second data item;
the first memory preference indicator specifies a first memory level for the first data item; and
the second memory preference indicator specifies a second memory level for the second data item, the second memory level being different than the first memory level.

9. The computer system of claim 1, wherein the memory resources comprise local memory and fabric-attached memory.

10. The computer system of claim 9, wherein the fabric-attached memory is implemented at least partially using COMPUTE EXPRESS LINK (CXL), and the memory resources of the fabric-attached memory comprises a plurality of memory devices arranged in zero or more tiers.

11. The computer system of claim 1, wherein the programming comprises instructions to compile the source code to generate executable code for the software application.

12. The computer system of claim 1, wherein the memory placement guidance of the memory allocation metadata comprises memory placement instructions for the data items.

13. The computer system of claim 1, further comprising transmitting the memory allocation metadata to a resource manager of an execution computing environment for execution of the software application according to the memory allocation metadata.

14. A computer-implemented method, comprising:
accessing, by a compiler, system configuration information describing memory resources of an execution computing environment, the memory resources being at least partially heterogeneous;
accessing, by the compiler, source code for a software application to be executed in the execution computing environment, the source code comprising memory preference indicators for data items associated with the software application, the memory preference indicators indicating one or more preferred memory characteristics for storing the data items in association with execution of the software application;
analyzing, by the compiler, the source code and the system configuration information to determine a mapping of the memory resources to the data items according to the memory preference indicators and system configuration information; and
generating, by the compiler and according to the mapping, memory allocation metadata comprising memory placement guidance for the data items.

15. The computer-implemented method of claim 14, wherein the memory resources correspond to a memory hierarchy that comprises a plurality of levels, each level of the plurality of levels being associated with a corresponding range of latency values, each memory resource of the memory resources corresponding to a level of the memory hierarchy.

16. The computer-implemented method of claim 14, wherein the memory resources comprise local memory and fabric-attached memory.

17. A computer system, comprising:
one or more processors; and
one or more non-transitory computer-readable storage media storing programming for execution by the one or more processors, the programming comprising instructions to:
obtain first compiled code and associated first memory allocation metadata for a first software application, the first memory allocation metadata comprising first memory placement guidance for allocating memory resources to data items of the first software application, the first memory placement guidance having been determined according to memory preference indicators included in first source code of the first software application;
determine available memory resources of the computer system, the available memory resources being at least partially heterogeneous;
allocate the available memory resources to the data items of the first software application according to the first memory placement guidance of the first memory allocation metadata; and
execute the first compiled code to run the first software application according to the allocation of the available memory resources to the data items of the first software application.

18. The computer system of claim 17, wherein the programming is part of an operating system of the computer system.

19. The computer system of claim 17, wherein:
the data items of the first software application comprise a first data item and a second data item;
the first memory placement guidance of the first memory allocation metadata comprises first memory placement instructions for the first data item and second memory placement instructions for the second data item;
the first memory placement instructions indicate a first memory level for the first data item;
the second memory placement instructions indicate a second memory level for the second data item, the second memory level being different than the first memory level; and
the instructions to allocate the available memory resources to the data items of the first software application according to the first memory placement guidance of the first memory allocation metadata comprise instructions to allocate memory resources of the available memory resources that are at the first memory level for the first data item and that are at the second memory level for the second data item.

20. The computer system of claim 17, wherein the programming further comprises instructions to:
obtain second compiled code and associated second memory allocation metadata for a second software application, the second memory allocation metadata comprising second memory placement guidance for allocating memory resources to data items of the second software application, the second memory placement guidance having been determined according to memory preference indicators included in source code of the second software application;
determine available memory resources of the computer system, the available memory resources being at least partially heterogeneous;
allocate the available memory resources to the data items of the second software application according to the memory placement guidance of the second memory allocation metadata; and
execute the second compiled code to run the second software application according to the allocation of the available memory resources to the data items of the second software application.
